(19) United States
(12) Patent Application Publication
(10) Pub. No.: US 2026/0120665 A1
(43) Pub. Date: Apr. 30, 2026

(54) PERCUSSION MALLET ASSEMBLY FOR OUTDOOR INSTRUMENTS

(71) Applicant: PlayCore Wisconsin, Inc., Chattanooga, TN (US)

(72) Inventors: Luke Hayworth, Chattanooga, TN (US); Thomas R. Norquist, Fort Payne, AL (US); Haoren Men, Auburn, AL (US)

(21) Appl. No.: 18/927,427

(22) Filed: Oct. 25, 2024

(51) Int. Cl. G10D 13/12

(52) U.S. Cl. CPC G10D 13/12

(57) ABSTRACT

An outdoor percussion mallet that provides a better user playing experience includes a mallet having a structural core that includes a cable extending through a bottom of the handle and terminating at a position within the interior of the mallet and a rigid tube surrounding the cable along at least a portion of the handle of the mallet. A flexible polymeric layer surrounds the structural core, e.g. a rubber layer may be molded directly onto the structural core to form the mallet. The mallet has a desired balance between flexibility and rigidity for playing percussion instruments. The opposite end of the cable may include an instrument-connection element that has increased strength relative to those used conventionally.

### BACKGROUND

Outdoor musical instruments installed in parks, playgrounds, and other public recreational areas provide unique and fun play opportunities for children and adults alike. Many of these instruments are percussion instruments that a user (or users) operates by striking a key, plate, dish, chime, or the like with a mallet. These instruments typically include one or more mallets attached to the instrument through a flexible cable. Those mallets however do not provide an optimal playing experience and can be subject to fatigue and failure, particularly where the cable is attached to the instrument and where the cable joins the handle of the mallet.

### SUMMARY OF THE INVENTION

The present disclosure is directed to an improved percussion mallet assembly for attachment to and use in conjunction with an outdoor percussion instrument. In particular, embodiments of the present percussion mallet assembly provide an improved user playing experience by providing a mallet having a desired balance between flexibility and rigidity. Embodiments of the present percussion mallet assembly also have features which provide the assembly with greater strength and durability, leading to a more robust mallet assembly that does not wear out and/or require replacement over an extended period of use.

Embodiments of the present disclosure are directed to a percussion mallet assembly that includes a mallet and a flexible cable. The mallet comprises a handle and a head, with the head being enlarged relative to the handle. A portion of the flexible cable runs internally through the mallet from a bottom end of the handle up to an internal position within the head. In some embodiments, an end of the cable may be inserted into a rigid stop element positioned within an interior of the head of the mallet, with stop preventing the cable from sliding out of the mallet. A rigid tube surrounds at least a portion of the flexible cable within the handle, and a flexible polymeric, e.g. rubber, layer surrounds the portion of the flexible cable running internally through the mallet and the rigid tube, thereby forming an outer layer of the mallet. This mallet configuration has been found to provide a desired balance between rigidity and flexibility for playing a percussion instrument, e.g. one that is more similar to a professional percussion mallet than those known in the art which tend to be either overly flexible (due to the lack of any rigid features in the handle) or overly rigid (due to having a rigid exterior sheath).

In some embodiments, the polymeric, e.g. rubber, outer layer may be a single, continuous element that forms the exterior surface of the mallet. This polymeric, e.g. rubber, layer may, for instance, be molded directly onto the portion of the flexible cable that runs internally through the mallet and the rigid tube that surrounds it, e.g. through cold molding, resin casting, injection molding, or the like. By providing the mallet with a single, continuous exterior surface element, there is less opportunities for breakage and/or failure than in the mallets shown in FIGS. 1A-1B, which have an additional cap element.

Moreover, in some embodiments the handle of the mallet may include a lower portion extending upward from the bottom end in which the rigid tube is not present. The polymeric, e.g. rubber, layer in the lower portion may include one or more strain relief features. In some embodiments, for instance, the one or more strain relief features may comprise or consist of a series of stepped reductions in cross-section, e.g. diameter, with the reductions being in a direction toward the bottom end of the handle. By providing a gradual, stepped reduction in cross-section, bending of the flexible cable that would typically occur at the junction between the cable and the bottom end of the mallet instead occurs within this lower portion. As this lower portion has a greater cross-sectional diameter than the cable itself, the fatigue on the cable is lessened and the assembly as a whole is strengthened against breakage.

In some embodiments that utilize both the internal mallet design and the fatigue-resistant lower portion of the handle, the rigid tube may extend through the entirety of the handle apart from the lower portion comprising the strain relief features.

The flexible cable may be configured to be attached to an outdoor instrument, e.g. through an attachment component positioned at an end of the cable opposite the mallet. In some embodiments, for instance, a metal eye terminal may be attached to an end of the cable opposite the mallet. This may be achieved in a variety of manners. For instance, an end of the cable opposite the mallet may be received by a body of the metal eye terminal. At least a portion of the body of the metal eye terminal and at least a portion of the cable adjacent the body of the eye terminal, i.e. at least the junction between the body of the metal eye terminal and the cable, may then be surrounded by a heat shrink tubing or other flexible material, e.g. over-molded rubber similar to that which forms an outer layer of the mallet.

By providing a metal instrument-attachment component of this sort, the mallet assembly of embodiments of the present disclosure may be provided with a stronger and more durable connection than conventional outdoor mallet cables, which are typically looped at the end such that the connection is between the flexible cable itself and a clasp that is installed on the instrument. This results in a more durable percussion mallet assembly and reduces the chances of breakage due to fatigue. Moreover, in some embodiments, at least a portion of the outer material that surrounds the junction between the flexible cable and the metal eye terminal may include one or more strain-relief features similar to that of the mallet, further protecting the junction from excessive wear.

Embodiments of the present disclosure are also directed to an outdoor musical instrument that includes at least one of the percussion mallet assemblies described herein. The outdoor musical instrument may in some instances be a metallophone having a plurality of keys that are struck by the one or more mallets or may comprise one or more chimes, plates, dishes, or the like, which are configured to be struck by the one or more mallets. The outdoor musical instrument may, for instance, include a clasp to which the metal eye terminal at the end of the flexible cable is secured. The clasp may be located somewhere on a framework and/or support post of the instrument. The outdoor musical instrument may, in some embodiments, also include one or more mallet holders that are configured to hold the one or more mallets when not in use.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1A is a side elevation view of a conventional outdoor percussion mallet.

FIG. 1B is a cross-sectional view of the conventional outdoor percussion mallet shown in FIG. 1A.

FIG. 2A is a side elevation view of an outdoor percussion mallet according to an embodiment of the present disclosure.

FIG. 2B is a cross-sectional view of the outdoor percussion mallet shown in FIG. 2A.

FIG. 3 is a side elevation view of an outdoor percussion mallet assembly according to an embodiment of the present disclosure.

FIG. 4 is a cross-sectional view of the detail identified in FIG. 3.

FIG. 5 is a cross-sectional view of detail identified in FIG. 3.

FIG. 6 is an exploded view of a structural core of the outdoor percussion mallet assembly shown in FIG. 3.

FIG. 7 is a cross-sectional view of the junction between the cable and the eye terminal of the outdoor percussion mallet assembly shown in FIG. 3.

FIG. 8 is a cross-section view of a junction between the cable and the eye terminal of an outdoor percussion mallet assembly according to another embodiment of the present disclosure.

### DETAILED DESCRIPTION OF THE INVENTION

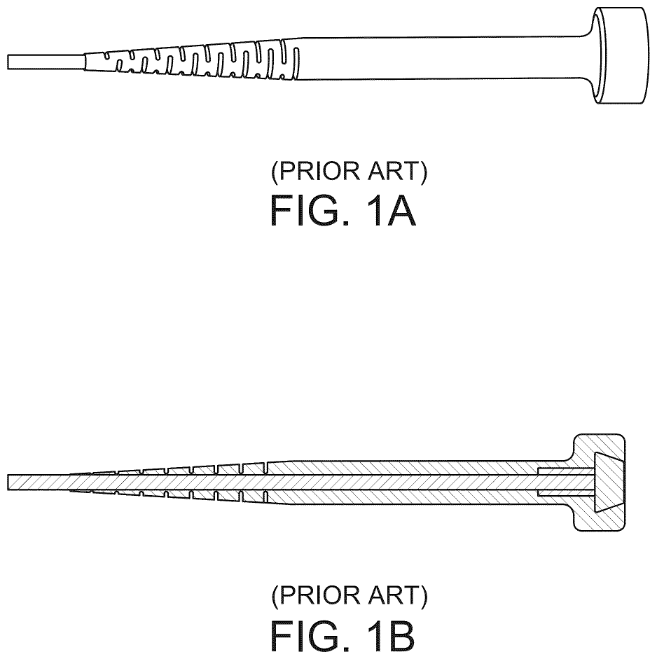

An embodiment of a conventional percussion mallet for use in conjunction with an outdoor musical instrument is shown in FIGS. 1A-1B. The conventional mallet comprises a handle and a head. A flexible cable extends into an interior of the mallet through a bottom end of the handle. That cable is held in place by a rubber stop, which forms part of the exterior surface of the mallet head. The handle of the mallet includes a lower portion that continuously reduces in diameter toward the bottom end and which includes a plurality of indentations that promote flexing. Because the handle of the mallet consists of the rubber outer body and the flexible cable running through its interior, the entirety of the handle is flexible. This produces a user experience that feels nothing like a standard percussion mallet, i.e. one used to play standard percussion instruments rather than one that was designed specifically for attachment to an outdoor-mounted musical instrument. Moreover, because the rubber plug forms part of the exterior surface of the mallet head, it offers a potential failure point.

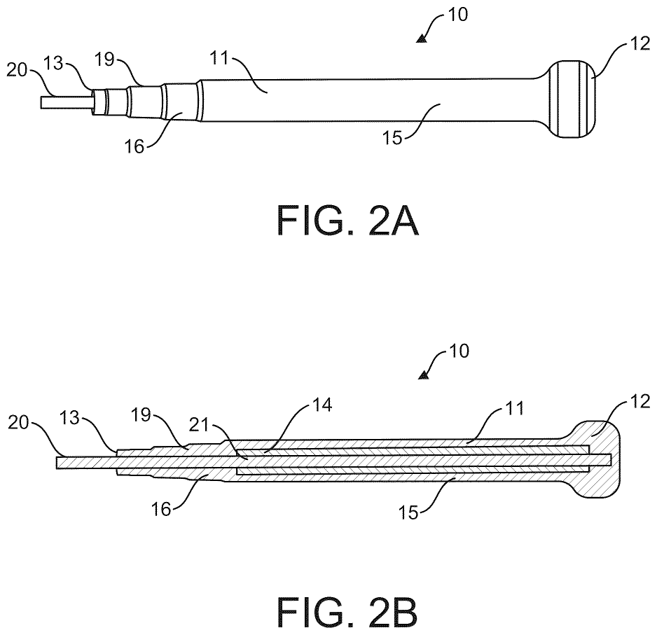

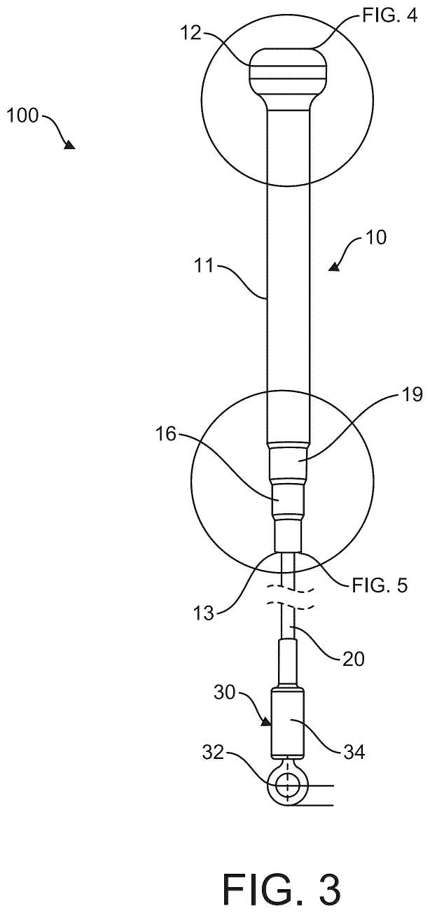

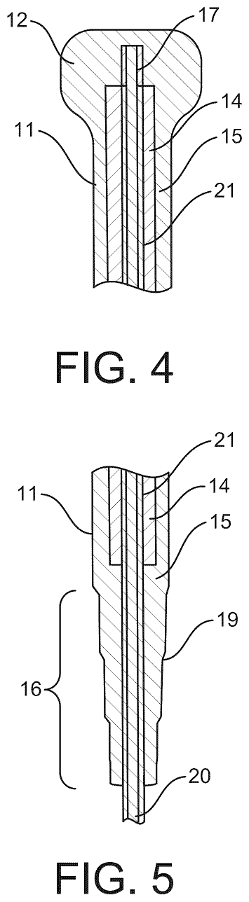

An embodiment of a percussion mallet 10 in accordance with the present disclosure is shown in FIGS. 2A-2B. As with the prior art, this mallet comprises a handle 11 and a head 12, with the head having an enlarged cross-section—e.g. diameter-relative to the handle. In contrast with the prior art, however, the mallet 10, and in particular a combination of the handle 11 and the head 12, of the embodiment of the present disclosure has a continuous outer surface that is formed by a single flexible, polymeric, e.g. rubber, component. The end of the mallet 10 opposite the head 12 is referred to herein as the bottom end 13 of the mallet or the bottom end of the handle. A flexible cable 20 extends through the bottom end 13 of the mallet 10 and into an interior of the handle 11.

As best seen in FIG. 2B, which shows a cross-section of the mallet taken along an axis extending between the bottom end 13 of the handle and the head 12 of the mallet 10, the flexible cable 20 extends from the bottom end of the handle through the center of the handle 11 up to a position within the interior of the mallet head. In addition to the flexible cable 20, however, the interior of the mallet 10 also includes a rigid tube 14 that surrounds at least a portion 21 of the flexible cable 20 that is within the handle 11. The rigid tube 14 may be made out of any of a variety of materials, including for example a rigid plastic such as nylon. The rigid tube 14 may be fully enclosed within a rubber layer 15 that forms the outer surface of the mallet 10. In the illustrated embodiment, for instance, the rigid tube 14 extends from a position at an interior of the head 12 of the mallet down to a position at or near which the handle 11 begins to decrease in cross-section to form a lower part 16 of the handle. In this manner, the rigid tube 14 extends through substantially the entire portion of the handle 11 that is configured to be gripped by a user during use. In alternative, non-illustrated, embodiments, however the rigid tube 14 may extend through a smaller length/proportion of the handle.

By including a rigid tube 14 that surrounds a portion of the flexible cable 21 passing through the center of the handle 11 of the mallet in this manner, the mallet 10 may be provided with a balance of flexibility and rigidity that more closely resembles a standard percussion mallet, i.e. one used to play standard percussion instruments rather than one that was designed specifically for attachment to an outdoor-mounted musical instrument, and thus provides a better instrument playing experience.

The outer surface of the mallet 10 is formed by a flexible polymeric, and in some embodiments rubber, layer 15. The flexible polymeric, e.g. rubber, layer 15 can be selected to provide a desired degree of softness. In some embodiments, for instance, the rubber used in the rubber layer 15 may have a Shore A durometer between about 70 and about 90, alternatively between about 75 and about 85, alternatively the rubber may have a Shore A diameter of about 80.

As shown in the illustrated embodiment, the flexible polymeric, e.g. rubber, component 15 may desirably provide a continuous outer surface. In order to produce such a mallet 10, for instance, the portion of the flexible cable 20 that extends into the mallet and the rigid tube 14 that surrounds at least a portion 21 of that cable may be inserted into a mold and the rubber component 15 may be directly molded around that core structure. The molding may be performed in any of a variety of conventional manners, including for example injection molding, cold molding, resin casting, and the like.

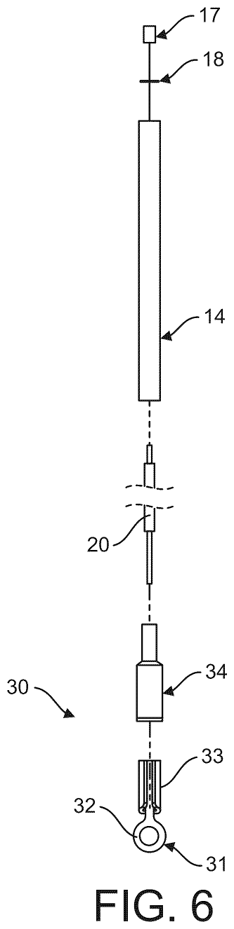

The interior of the mallet 10 may further comprise a rigid stop element 17 positioned at an end of the portion of the flexible cable 20 that is enclosed within the mallet. The rigid stop element 17 may be made of any of a variety of materials, including for example metals such as stainless steel, zinc-plated copper, or the like. The rigid stop element 17 receives the end of the flexible cable 20 and is configured to prevent the flexible cable 20 from being pulled out of the bottom end 13 of the handle 11. As illustrated in FIG. 6, for example, the end of the flexible cable 20 may have a polymeric, e.g. PVC, jacket removed and a woven metal core of the cable may be received by the rigid stop element 17 and fused therein, e.g. by a cold-working forging process such as swaging.

In the illustrated embodiment, the rigid stop element 17 is positioned within an interior of the head 12 of the mallet, which also serves to give the head of the mallet a desired weight for striking a percussion instrument. In other embodiments, however, the rigid stop element may be positioned at location within the handle 11 of the mallet 10. Moreover, as illustrated in FIG. 6, a washer 18 may be positioned between the rigid stop element 17 and the rigid tube 14.

In the illustrated embodiment, the handle 11 comprises a lower portion 16 in which the cross-section, e.g. diameter, of the handle decreases toward the bottom end 13 of the handle. This lower portion 16 is configured to flex in order to allow the mallet 10 to be moved between a variety of orientations and positions. Given the purpose of this lower portion 16, the rigid tube 14 is generally not present in the lower portion. In some embodiments, however, this lower portion 16 may comprise one or more strain relief features 19. The one or more strain relief features 19 is/are configured to promote flexing of this portion of the handle, thereby reducing strain on the flexible cable 20 when moving the mallet 10 between various orientations and positions. In the illustrated embodiment, the one or more strain relief features 19 take the form of a series of stepped reductions in cross-section in a direction toward the bottom end 13 of the handle. In alternative embodiments however the strain relief features 19 may take on any of a variety of other forms including, for example, one or more indentations that promote flexing of the lower portion 16 of the handle 11.

In addition to providing an improved percussion mallet 10, embodiments of the present disclosure relate to an improved attachment component 30 by which the flexible cable 20 may be attached to an outdoor instrument. In the illustrated embodiment, for example, the attachment component 30 may include a metal eye terminal 31. The metal eye terminal 31 comprises an eye portion 32 and a body portion 33. By providing a metal eye terminal 31 that has the eye portion 32 joined to a metal clamp installed on a portion of the instrument, the connection between the flexible cable 20 and the outdoor instrument can by made significantly more durable than the attachment mechanism used conventionally, which involves looping a portion of the flexible cable through the clamp and leads to heavy wear on the cable.

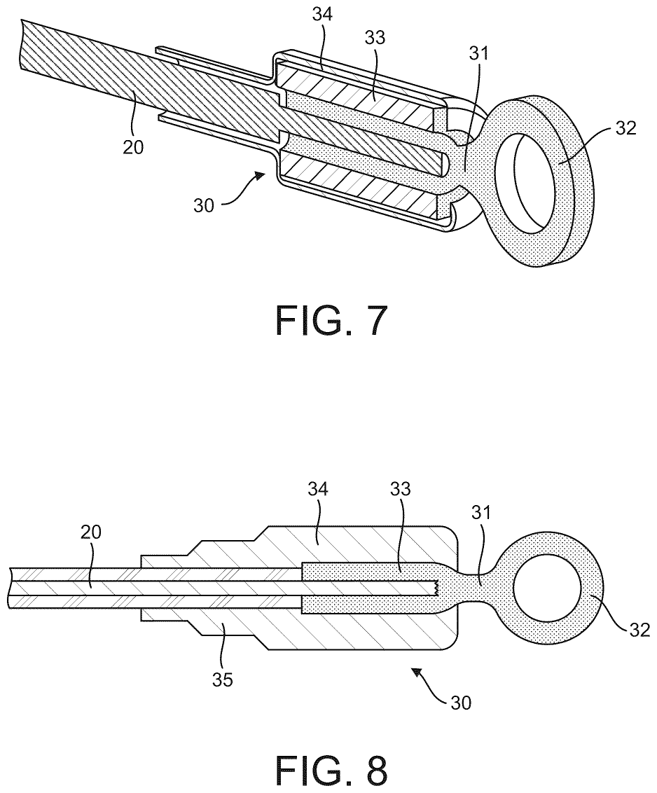

The flexible cable 20 may be joined to the metal eye terminal 31 in a variety of ways. In the embodiment illustrated in FIG. 7, the end of the flexible cable 20 may have a polymeric jacket removed, exposing a woven metal core of the cable, which may be received by a central opening in the body 33 of the metal eye terminal 31 and held therein, e.g. by a cold-working forging process such as swaging. The junction between the flexible cable 20 and the metal eye terminal 31, and more specifically the body 33 of the metal eye terminal, is surrounded by a heat-shrink tubing or over-molded polymeric or rubber material 34 in order to further strengthen the junction. As shown in illustrated embodiment, at least a portion of the body 33 of the metal eye terminal 31 and at least a portion of the cable 20 adjacent the body of the eye terminal may be surrounded by a heat shrink tubing 34.

Another embodiment of a flexible cable 20 and metal eye terminal 31 is illustrated in FIG. 8. Similar to the embodiment shown in FIG. 7, the end of the flexible cable 20 has the polymeric jacket removed, exposing the woven metal core of the cable. The body 33 of the metal eye terminal 31 is then swaged over the end of the woven metal core, thereby joining them via a cold-working forging process. The junction between the flexible cable 20 and metal eye terminal 31 is then covered by an over-molded polymeric or rubber material 34, e.g. in a manner similar to the mallet. In the illustrated embodiment, the over-mold material 34 is provided with one or more, and optionally a series of, strain-relief features 35 similar to those shown on the mallet in a region surrounding a portion of the flexible cable 20.

The one or more strain relief features 35 is/are configured to promote flexing of this portion of the junction between the flexible cable 20 and the metal eye terminal 31, thereby reducing strain on the flexible cable 20 when moving it between various orientations and positions. In the illustrated embodiment, the one or more strain relief features 35 take the form of a series of stepped reductions in cross-section in a direction away from the eye portion 32 of the metal eye terminal 31. In alternative embodiments however the strain relief features 35 may take on any of a variety of other forms including, for example, one or more indentations that promote flexing of the over-mold material 34 in the region that surrounds the flexible cable 20.

It can be seen that the described embodiments provide unique and novel percussion mallets 10 and percussion mallet assemblies 100 that have a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A percussion mallet assembly comprising:
a mallet comprising a handle and a head, the head being enlarged relative to the handle; and
a flexible cable, the flexible cable being configured to be attached to an outdoor instrument;
wherein a portion of the flexible cable runs internally through the mallet from a bottom end of the handle up to an internal position within the head;
wherein a rigid tube surrounds at least a portion of the flexible cable within the handle;
wherein a rubber layer surrounds the portion of the flexible cable running internally through the mallet and the rigid tube.

2. The percussion mallet assembly of claim 1, wherein the rubber layer forms the exterior surface of the mallet.

3. The percussion mallet assembly of claim 2, wherein the rubber layer is a single continuous element.

4. The percussion mallet assembly of claim 3, wherein the rubber layer is molded directly onto the portion of the flexible cable that runs internally through the mallet and the rigid tube that surrounds it.

5. The percussion mallet assembly of claim 1, wherein the rubber layer has a Shore A durometer of about 80.

6. The percussion mallet assembly of claim 1, wherein the handle includes a lower portion extending upward from the bottom end in which the rigid tube is not present; and wherein the rubber layer in the lower portion comprises one or more strain relief features.

7. The percussion mallet assembly of claim 6, wherein the one or more strain relief features comprises a series of stepped reductions in cross-section in a direction toward the bottom end.

8. The percussion mallet assembly of claim 6, wherein the rigid tube extends through the entirety of the handle apart from the lower portion comprising the strain relief features.

9. The percussion mallet assembly of claim 1, wherein an end of the cable is inserted into a rigid stop element positioned within an interior of the head of the mallet.

10. The percussion mallet assembly of claim 9, wherein the end of the cable has a polymeric jacket removed and a metal core of the cable is joined to the rigid stop element.

11. The percussion mallet assembly of claim 1, further comprising a metal eye terminal attached to an end of the cable opposite the mallet.

12. The percussion mallet assembly of claim 11, wherein an end of the cable opposite the mallet is received by a body of the metal eye terminal.

13. The percussion mallet assembly of claim 12, wherein the end of the cable has a polymeric jacket removed and a metal core of the cable is joined to the body of the metal eye terminal.

14. The percussion mallet assembly of claim 12, wherein at least a portion of the body of the metal eye terminal and at least a portion of the cable adjacent the body of the eye terminal are surrounded by a heat shrink tubing or flexible over-molded material.

15. The percussion mallet assembly of claim 14, wherein a portion of the heat shrink tubing or flexible over-molded material is provided with one or more strain relief features.

16. The percussion mallet assembly of claim 15, wherein the one or more strain relief features comprises a series of stepped reductions in cross-section in a direction away from an eye of the metal eye terminal.

17. An outdoor musical instrument comprising the percussion mallet assembly of claim 1.

18. The outdoor musical instrument of claim 17, wherein the instrument comprises one or more bars, plates, dishes, or chimes that are configured to be struck by the mallet.

19. An outdoor musical instrument comprising the percussion mallet assembly of claim 11, wherein the metal eye terminal is attached to a clamp that is secured to a portion of the musical instrument.

20. The outdoor musical instrument of claim 19, wherein the instrument comprises one or more bars, plates, dishes, or chimes that are configured to be struck by the mallet.
